(19) United States
(12) Patent Application Publication
(10) Pub. No.: US 2008/0190767 A1
(43) Pub. Date: Aug. 14, 2008

(54) LAMINATED GAS SENSOR HAVING IMPROVED STRUCTURE FOR RELIABLY PREVENTING CRACKS

(75) Inventors: Makoto NAKAE, Nagoya (JP); Kiyomi Kobayashi, Kuwana-shi (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 11/959,964

(22) Filed: Dec. 19, 2007

(30) Foreign Application Priority Data
Dec. 21, 2006 (JP) 2006-343826

(51) Int. Cl. G01N 27/30

(52) U.S. Cl. 204/424

(57) ABSTRACT

A laminated gas sensor includes a solid electrolyte layer, a measurement gas chamber, a reference gas chamber, a measurement gas chamber formation layer, and a reference gas chamber formation layer. The measurement gas chamber formation layer has an opposite pair of inner side surfaces that extend in a longitudinal direction of the solid electrolyte layer and face each other in a lateral direction of the solid electrolyte layer through the measurement gas chamber. The reference gas chamber formation layer has an opposite pair of inner side surfaces that extend in the longitudinal direction and face each other in the lateral direction through the reference gas chamber. Further, at least one of the inner side surfaces of the measurement gas chamber formation layer is located more inside the laminated gas sensor than a corresponding one of the inner side surfaces of the reference gas chamber formation layer in the lateral direction.

### CROSS-REFERENCE TO RELATED APPLICATION

This application is based on and claims priority from Japanese Patent Application No. 2006-343826, filed on Dec. 21, 2006, the content of which is hereby incorporated by reference in its entirety into this application.

### BACKGROUND OF THE INVENTION

1. Technical Field of the Invention

The present invention relates to a laminated gas sensor for sensing the concentration of a specific component, for example O2 or NOx, in the exhaust gas of a motor vehicle.

2. Description of the Related Art

In order to prevent air pollution, regulations on exhaust gases of automotive engines have been becoming increasingly strict year after year. For decreasing harmful components included in the exhaust gases, there have been developed systems that employ a gas sensor to detect the concentration of a specific gas component in an exhaust gas passage of the engine and suppress the amount of harmful components in the exhaust gas through combustion control of the engine based on the detected concentration. For the same purpose, there have also been developed systems that employ a gas sensor to detect the concentration of O2 or NOx in the exhaust gas of the engine, determine the combustion condition of the engine on the basis of the detected concentration, and feedback control the fuel injection or air/fuel ratio of the engine.

Gas sensors for such usages were cup-shaped in the past. However, laminated gas sensors have now come to replace those cup-shaped gas sensors in view of prompt activation and high functional capability. Laminated gas sensors are generally made by laminating and firing together a sensor portion and a heater portion.

For example, Japanese Patent Application Publication No. 2004-333205 discloses a laminated gas sensor that includes a diffusion resistor portion, a measurement gas chamber into which a gas to be measured is introduced through the diffusion resistor portion, a solid electrolyte sheet conductive of oxygen ion, a measurement electrode fixed on a surface of the solid electrolyte sheet so as to be exposed to the gas within the measurement gas chamber, a reference electrode fixed on another surface of the solid electrolyte sheet to form an electrochemical cell together with the measurement electrode.

FIGS. 8, 9A and 9B together show a conventional laminated gas sensor 1B, which includes a sensor portion 20B and a heater portion 19 that are laminated and fired together.

The sensor portion 20B includes a porous gas diffusion layer 14, a measurement gas chamber formation layer 13B, a solid electrolyte layer 11, and a reference gas chamber formation layer 12. The porous gas diffusion layer 14 is made of, for example, alumina. The measurement gas chamber formation layer 13B has an opening for forming a measurement gas chamber 130B. The solid electrolyte layer 11 is made of, for example, partially stabilized zirconia. The reference gas chamber formation layer 12 has a substantially U-shaped cross section for forming a reference gas chamber 120.

On an upper surface 111 of the solid electrolyte layer 11, there are formed, for example by printing, a measurement electrode 21, a measurement lead 211, a measurement electrode terminal 212 that is connected to the measurement electrode 21 via the measurement lead 211, and a reference electrode terminal 224. On the other hand, on a lower surface 112 of the solid electrolyte layer 11, there are formed, for example by printing, a reference electrode 22 and reference leads 221 and 222. The reference leads 221 and 222 connect the reference electrode 22 to the reference electrode terminal 224 via a through-hole terminal 223 formed in the solid electrolyte layer 11.

The gas diffusion layer 14 is fixed to the upper surface 111 of the solid electrolyte layer 11 via the measurement gas chamber formation layer 13B. As a result, there is formed the measurement gas chamber 130B that is surrounded by the gas diffusion layer 14, the measurement gas chamber formation layer 131, and the upper surface 111 of the solid electrolyte layer 11. On the other hand, the reference gas chamber formation layer 12 is fixed to the lower surface 112 of the solid electrolyte layer 11. As a result, there is formed the reference gas chamber 120 that is surrounded by the lower surface 112 of the solid electrolyte layer 11 and the reference gas chamber formation layer 12.

The heater portion 19 includes a heater substrate 190, a heater element 191, a pair of heater leads 192 connected to the heater element 191, and a pair of heater terminals 194. The heater substrate 190 is made, for example, of alumina. The heater element 191 and heater leads 192 are formed, for example by printing, on an upper surface 195 of the heater substrate 190. On the other hand, the heater terminals 194 are formed, for example by printing, on a lower surface 196 of the heater substrate 190 and respectively connected to the heater leads 192 via through-hole electrodes 193 formed in the heater substrate 190.

In the above laminated gas sensor 1B, however, hollow spaces (i.e., the measurement gas chamber 130B and reference gas chamber 120) are formed on both the upper and lower sides of the solid electrolyte layer 11. Accordingly, that portion of the solid electrolyte layer 11 which is interposed between the hollow spaces has a lower strength than the other portions. Thus, during the firing and cooling processes of the laminated gas sensor 1B, cracks may occur in the solid electrolyte layer 11.

More specifically, refereeing to FIGS. 9A and 9B, cracks may occur in the solid electrolyte layer 11 around the intersections between the upper surface 111 of the solid electrolyte layer 11 and an opposite pair of inner side surfaces 131B of the measurement gas chamber formation layer 13B; the inner side surfaces 131B extend in the longitudinal direction of the solid electrolyte layer 11 and face each other through the measurement gas chamber 130B formed therebetween.

Such cracks existing in the solid electrolyte layer 11 are difficult to be found from the outside of the laminated gas sensor 1B, thus significantly lowering the reliability of the sensor 1B. Therefore, it is necessary to reliably prevent cracks from occurring in the solid electrolyte layer 11 during manufacturing of the laminated gas sensor 1B.

In particular, when the laminated gas sensor 1B is used to detect the concentration of O2 in the exhaust gas of an automotive engine, it will be rapidly heated to a high temperature of above 500° C. Thus, if there exist cracks in the solid electrolyte layer 11, the cracks will progress due to heat stress, resulting in damage of the laminated gas sensor 1B.

### SUMMARY OF THE INVENTION

The present invention has been made in view of the above-mentioned problems.

It is, therefore, a primary object of the present invention to provide a laminated gas sensor that has an improved structure for reliably preventing occurrence of cracks in a solid electrolyte layer of the laminated gas sensor during manufacturing.

According to the present invention, there is provided a laminated gas sensor which includes a solid electrolyte layer, a measurement gas chamber, a reference gas chamber, a measurement electrode, a reference electrode, a measurement gas chamber formation layer, and a reference gas chamber formation layer.

The solid electrolyte layer has an opposite pair of first and second major surfaces. The first and second major surfaces have a length and a width, thereby defining longitudinal and lateral directions of the solid electrolyte layer. The measurement gas chamber and reference gas chamber are respectively formed on the first and second major surfaces of the solid electrolyte layer. A gas to be measured and a reference gas are to be respectively introduced into the measurement gas chamber and reference gas chamber. The measurement electrode is provided on the first major surface of the solid electrolyte layer and within the measurement gas chamber, so as to be exposed to the gas. The reference electrode is provided on the second major surface of the solid electrolyte layer and within the reference gas chamber, so as to be exposed to the reference gas. The measurement gas chamber formation layer has a first hollow space formed therein, and is laminated on the first major surface of the solid electrolyte layer so that the first hollow space makes up the measurement gas chamber. The measurement gas chamber formation layer has an opposite pair of inner side surfaces that extend in the longitudinal direction of the solid electrolyte layer and face each other in the lateral direction of the solid electrolyte layer through the measurement gas chamber formed therebetween. The reference gas chamber formation layer has a second hollow space formed therein, and is laminated on the second major surface of the solid electrolyte layer so that the second hollow space makes up the reference gas chamber. The reference gas chamber formation layer has an opposite pair of inner side surfaces that extend in the longitudinal direction of the solid electrolyte layer and face each other in the lateral direction of the solid electrolyte layer through the reference gas chamber formed therebetween.

Further, in the laminated gas sensor, at least one of the inner side surfaces of the measurement gas chamber formation layer is located more inside the laminated gas sensor than a corresponding one of the inner side surfaces of the reference gas chamber formation layer in the lateral direction of the solid electrolyte layer.

With the above configuration, inward tensions will act on the solid electrolyte layer due to the weight of that portion of the solid electrolyte layer which is interposed between the measurement gas chamber and reference gas chamber and the weights of the measurement and reference electrodes. The acting positions of the inward tensions respectively coincide, in the lateral direction of the solid electrolyte layer, with the intersections between the inner side surfaces of the reference gas chamber formation layer and the second major surface of the solid electrolyte layer. Further, during a firing process in manufacturing the laminated gas sensor, outward tensions will act on the solid electrolyte layer due to shrinkage of the measurement gas chamber formation layer. The acting positions of the outward tensions are respectively at the intersections between the inner side surfaces of the measurement gas chamber formation layer and the first major surface of the solid electrolyte layer.

Since the at least one of the inner side surfaces of the measurement gas chamber formation layer is located more inside the laminated gas sensor than the corresponding one of the inner side surfaces of the reference gas chamber formation layer in the lateral direction of the solid electrolyte layer, the acting position of at least one of the outward tensions is staggered from that of a corresponding one of the inward tensions.

Consequently, the at least one outward tension will be canceled by the corresponding inward tension, and thus stress will be significantly alleviated in the solid electrolyte layer. As a result, cracks can be reliably prevented from occurring in the solid electrolyte layer, thereby securing the reliability of the laminated gas sensor.

According to a further implementation of the invention, the at least one of the inner side surfaces of the measurement gas chamber formation layer extends in zigzags in the longitudinal direction of the solid electrolyte layer, forming a stress deconcentration portion of the measurement gas chamber formation layer which protrudes inward from the corresponding one of the inner side surfaces of the reference gas chamber formation layer in the lateral direction of the solid electrolyte layer.

With the stress deconcentration portion, stress will be further alleviated in the solid electrolyte layer, thereby further reliably preventing cracks from occurring in the solid electrolyte layer.

The stress deconcentration portion of the measurement gas chamber formation layer has a cross section which is parallel to the first major surface of the solid electrolyte layer and shaped in a wave that includes a plurality of tops and bottoms alternately arranged in the longitudinal direction of the solid electrolyte layer.

With such a wave shape of the cross section, stress can be further effectively deconcentrated on the first major surface of the solid electrolyte layer, thereby further reliably preventing cracks from occurring in the solid electrolyte layer.

Further, the wave may be either a triangular, sine, or rectangular wave.

Furthermore, it is preferable that 0.2 T<H<2.5 T, where T is a pitch of the wave, and H is a height of the wave.

It is also preferable that the wave includes less than or equal to 50 pairs of tops and bottoms.

### BRIEF DESCRIPTION OF THE DRAWINGS

The present invention will be understood more fully from the detailed description given hereinafter and from the accompanying drawings of one preferred embodiment of the invention, which, however, should not be taken to limit the invention to the specific embodiment but are for the purpose of explanation and understanding only.

In the accompanying drawings:

FIG. 1 is an exploded perspective view of a laminated gas sensor according to an embodiment of the invention;

FIG. 2A is a lateral cross-sectional view of the laminated gas sensor of FIG. 1;

FIG. 2B is a cross-sectional view taken along the line A-A in FIG. 2A;

FIGS. 3A and 3B are schematic cross-sectional views illustrating the mechanism of occurrence of cracks in conventional laminated gas sensors;

FIGS. 4A and 4B are schematic cross-sectional views illustrating the advantages of the laminated gas sensor of FIG. 1 in preventing occurrence of cracks;

FIGS. 5A, 5B, and 5C show variations of stress deconcentration portions of a solid electrolyte layer in the laminated gas sensor of FIG. 1;

FIG. 6 is a graphical representation showing the results of an experimental investigation for confirming the advantages of the laminated gas sensor of FIG. 1;

FIGS. 7A and 7B show laminated gas sensors of different types to which the invention can be applied;

FIG. 8 is an exploded perspective view of a conventional laminated gas sensor;

FIG. 9A is a lateral cross-sectional view of the conventional laminated gas sensor with an indication of cracks-occurring positions; and

FIG. 9B is a cross-sectional view taken along the line A-A in FIG. 9A with an indication of the cracks-occurring positions.

### DESCRIPTION OF PREFERRED EMBODIMENT

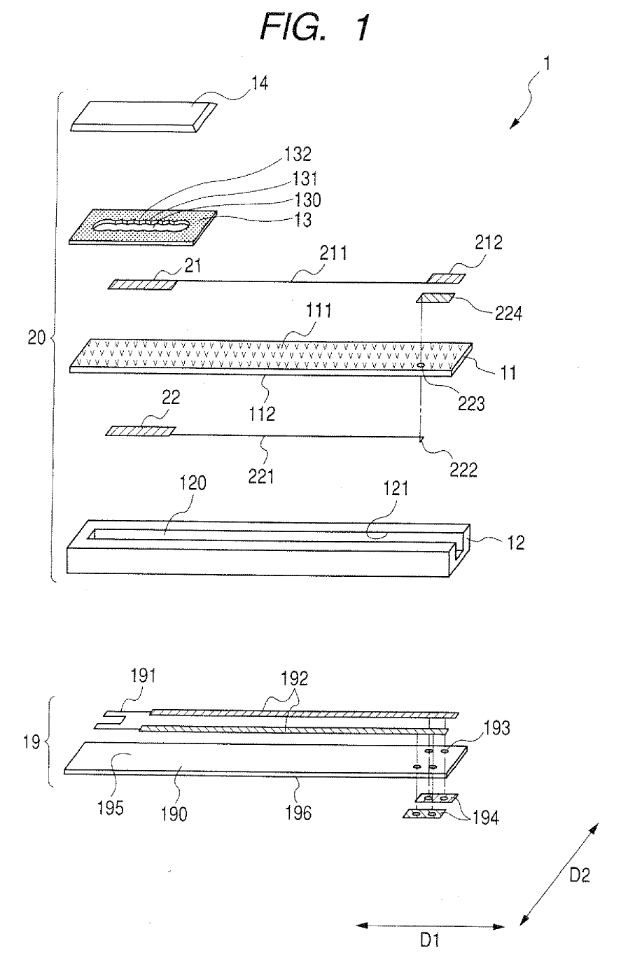

One preferred embodiment of the present invention will be described hereinafter with reference to FIGS. 1-6.

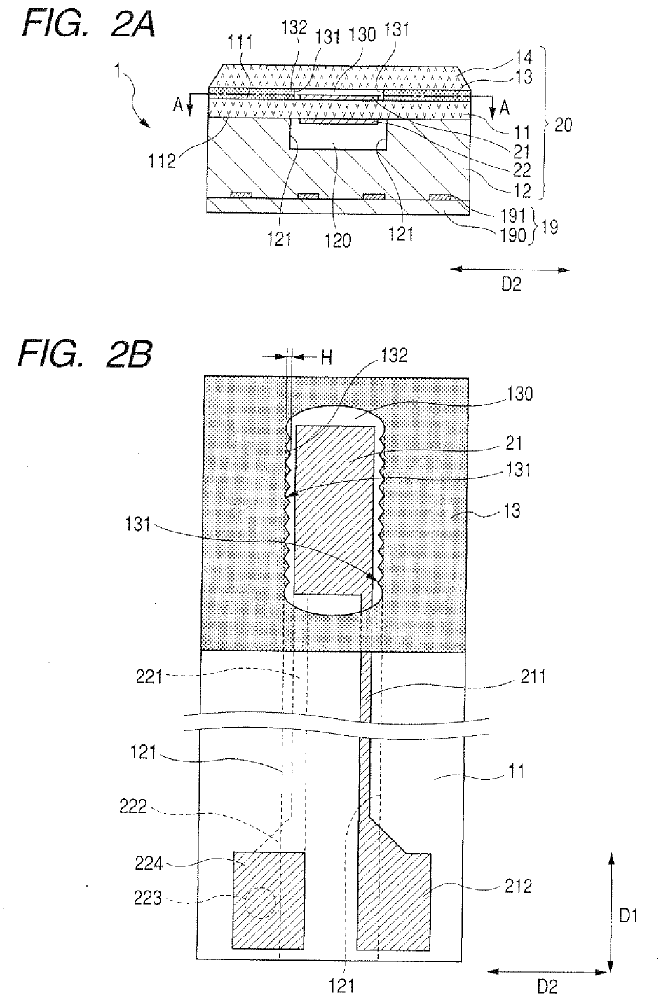

FIGS. 1, 2A and 2B together show the overall configuration of a laminated gas sensor 1 according to an embodiment of the invention. As shown, the laminated gas sensor 1 includes a sensor portion 20 and a heater portion 19 that are laminated and fired together.

The sensor portion 20 includes a porous gas diffusion layer 14, a measurement gas chamber formation layer 13, a solid electrolyte layer 11, and a reference gas chamber formation layer 12. The porous gas diffusion layer 14 is made of, for example, alumina. The measurement gas chamber formation layer 13 has an opening for forming a measurement gas chamber 130. The solid electrolyte layer 11 is made of, for example, partially stabilized zirconia. The reference gas chamber formation layer 12 has a substantially U-shaped cross section for forming a reference gas chamber 120.

The solid electrolyte layer 11 has an opposite pair of major surfaces, i.e., an upper surface 111 and a lower surface 112. The upper and lower surfaces 111 and 112 have a given length and a given width, thereby defining longitudinal and lateral directions D1 and D2 of the solid electrolyte layer 11.

On the upper surface 111 of the solid electrolyte layer 11, there are formed, for example by printing, a measurement electrode 21, a measurement lead 211, a measurement electrode terminal 212 that is connected to the measurement electrode 21 via the measurement lead 211, and a reference electrode terminal 224. On the other hand, on the lower surface 112 of the solid a electrolyte layer 11, there are formed, for example by printing, a reference electrode 22 and reference leads 221 and 222. The reference leads 221 and 222 connect the reference electrode 22 to the reference electrode terminal 224 via a through-hole terminal 223 formed in the solid electrolyte layer 11.

The gas diffusion layer 14 is fixed to the upper surface 111 of the solid electrolyte layer 11 via the measurement gas chamber formation layer 13. As a result, there is formed the measurement gas chamber 130 that is surrounded, as best shown in FIG. 2A, by the gas diffusion layer 14, the measurement gas chamber formation layer 13, and the upper surface 111 of the solid electrolyte layer 11. Further, the measurement electrode 21 is located within the measurement gas chamber 130, so as to be exposed to a measurement gas (i.e., a gas to be measured) that is to be introduced into the measurement gas chamber 130.

On the other hand, the reference gas chamber formation layer 12 is fixed to the lower surface 112 of the solid electrolyte layer 11. As a result, there is formed the reference gas chamber 120 that is surrounded, as best shown in FIG. 2A, by the lower surface 112 of the solid electrolyte layer 1 and the reference gas chamber formation layer 12. Further, the reference electrode 22 is located within the reference gas chamber 120, so as to be exposed to a reference gas that is to be introduced into the reference gas chamber 120.

The measurement gas chamber formation layer 13 has, as best shown in FIG. 2B, an opposite pair of inner side surfaces 131 that extend in the longitudinal direction D1 of the solid electrolyte layer 11 and face each other through the measurement gas chamber 130 formed therebetween. On the other hand, the reference gas chamber formation layer 12 has, as shown in FIG. 2A, an opposite pair of inner side surfaces 121 that extend in the longitudinal direction D1 of the solid electrolyte layer 11 and face each other through the reference gas chamber 120 formed therebetween.

In the present embodiment, as shown in FIG. 2A, each of the inner side surfaces 131 of the measurement gas chamber formation layer 13 is located inner (i.e., more inside the laminated gas sensor 1) than a corresponding one of the inner side surfaces 121 of the reference gas chamber formation layer 12.

Further, as shown in FIG. 2B, each of the inner side surfaces 131 of the measurement gas chamber formation layer 13 extends in zigzags in the longitudinal direction D1 of the solid electrolyte layer 11, forming a stress deconcentration portion 132 of the measurement gas chamber formation layer 13 which protrudes inward from the corresponding one of the inner side surfaces 121 of the reference gas chamber formation layer 12.

The stress deconcentration portions 132 of the measurement gas chamber formation layer 13 each have a cross section parallel to the upper surface 111 of the solid electrolyte layer 11, which has, as shown in FIG. 2B, the shape of a wave that includes a plurality of tops and bottoms alternately arranged in the longitudinal direction D1 of the solid electrolyte layer 11. The wave has a height H in the lateral direction D2 of the solid electrolyte layer 11. In other words, each of the stress deconcentration portions 132 of the measurement gas chamber formation layer 13 protrudes inward from the corresponding one of the inner side surfaces 121 of the reference gas chamber formation layer 12 by H.

The heater portion 19 includes a heater substrate 190, a heater element 191, a pair of heater leads 192 connected to the heater element 191, and a pair of heater terminals 194. The heater substrate 190 is made, for example, of alumina. The heater element 191 and heater leads 192 are formed, for example by printing, on an upper surface 195 of the heater substrate 190. On the other hand, the heater terminals 194 are formed, for example by printing, on a lower surface 196 of the heater substrate 190 and respectively connected to the heater leads 192 via through-hole electrodes 193 formed in the heater substrate 190.

The laminated gas sensor 1 according to the present embodiment can be made, for example, in the following way.

First, the solid electrolyte layer 11 is prepared. More specifically, a slurry is obtained by dispersing a yttria stabilized zirconia powder, along with sintering aids, a binder (e.g., polyvinyl butyral), and a plasticizer (e.g., dibutyl phthalate), in a solvent (e.g., an organic solvent); the slurry is formed into a green sheet of a given thickness using a doctor blade method; the green sheet is dried and cut into a rectangle of a given size; a through-hole is further bored in the green sheet for forming the through-hole terminal 223.

Secondly, a platinum paste having the same slurry as in the first step added thereto is printed on the upper surface 111 of the solid electrolyte layer 11 to form the measurement electrode 21, the measurement lead 211, the measurement electrode terminal 212, and the reference electrode terminal 224. The platinum paste is also printed on the lower surface 112 of the solid electrolyte layer 11 to form the reference electrode 22 and the reference leads 221 and 222. The platinum paste is further printed on the inner surface of the solid electrolyte layer 11 defining the through-hole to form the through-hole electrode 223.

Thirdly, the reference gas chamber formation layer 12 is prepared. More specifically, an alumina slurry is obtained by dispersing an alumina powder, along with sintering aids, a binder, and a plasticizer, in a solvent (e.g., an organic solvent); the alumina slurry is formed into alumina green sheets of a given thickness using the doctor blade method; the alumina green sheets are dried, cut, and laminated to form the reference gas chamber formation layer 12 which has the substantially U-shaped cross section.

Fourthly, the heater substrate 190 is prepared. More specifically, an alumina green sheet of a given thickness is obtained in the same manner as in the third step; it is then dried and cut into a rectangle of a given size, and through-holes are further bored in it for forming the through-hole electrodes 193.

Fifthly, a platinum paste having the same alumina slurry as in the third step added thereto is printed on the upper surface 195 of the heater substrate 190 to form the heater element 191 and the heater leads 192. The platinum paste is also printed on the lower surface 196 of the heater substrate 190 to form the heater terminals 194. The platinum paste is further printed on the inner surfaces of the heater substrate 190 defining the through-holes to form the through-hole terminals 193.

Sixthly, the porous gas diffusion layer 14 is prepared. More specifically, a second alumina slurry is obtained by dispersing an alumina power having a larger diameter than that in the third step, along with a binder and a plasticizer, in a solvent; the second alumina slurry is formed into a second alumina green sheet of a given thickness using the doctor blade method; the second alumina green sheet is dried and cut into a desired shape to form the gas diffusion layer 14.

Seventhly, the measurement gas chamber formation layer 13 is formed on the upper surface 111 of the solid electrolyte layer 11. More specifically, an adhesive paste, which is obtained by adding more the binder into the same slurry as in the first step, is printed on the supper surface 111 of the solid electrolyte layer 11 to form the measurement gas chamber formation layer 13.

In addition, it should be noted that the adhesive paste may also be obtained by adding the more binder into a mixture of the slurries of the first and sixth steps

Eighthly, the porous gas diffusion layer 14 is joined onto the measurement gas chamber formation layer 13 using the adhesion of the layer 13.

Ninthly, the reference gas chamber formation layer 12 is laminated on the lower surface 112 of the solid electrolyte layer 11 to form the sensor portion 20.

Tenthly, the sensor portion 20 and heater portion 19 are fixed together, for example by hot pressing or adhesive bonding, to form a gas sensor laminate.

Finally, the gas sensor laminate is dried, degreased, and fired to form the laminated gas sensor 1.

The laminated gas sensor 1 according to the present embodiment can be used, for example, in the following way.

A voltage differential meter (not shown) is connected to the measurement electrode terminal 212 and reference electrode terminal 224. A power source (not shown) is connected to the heater terminals 194. An electronic control unit (not shown) controls electric power supply from the power source to the heater element 191, so as to heat the sensor portion 20 to a given temperature to activate it.

The porous gas diffusion layer 14 is exposed to a measurement gas (e.g. the exhaust gas of an automotive engine), thereby introducing the measurement gas into the measurement gas chamber 130. On the other hand, an entrance of the reference gas chamber 120 is opened to a reference gas (e.g., air), thereby introducing the reference gas into the reference gas chamber 120. Consequently, the measurement electrode 21 and reference electrode 22 are respectively exposed to the measurement and reference gases.

The solid electrolyte layer 11 may be conductive of, for example, oxygen ion. In this case, a difference in electric potential between the measurement electrode 21 and reference electrode 22 is created depending on the difference in oxygen concentration between the measurement and reference gases. Accordingly, by measuring the electric potential difference, it is possible to determine the concentration of oxygen in the measurement gas.

The laminated gas sensor 1 according to the present embodiment has, compared to the conventional laminated gas senor 1B described previously, an improved structure by which cracks can be reliably prevented from occurring in the solid electrolyte layer 11 during manufacturing. The mechanism of occurrence of cracks in the conventional laminated gas sensor 113 and the reason why the occurrence of cracks can be prevented in the laminated gas sensor 1 of the present embodiment will be descried hereinafter.

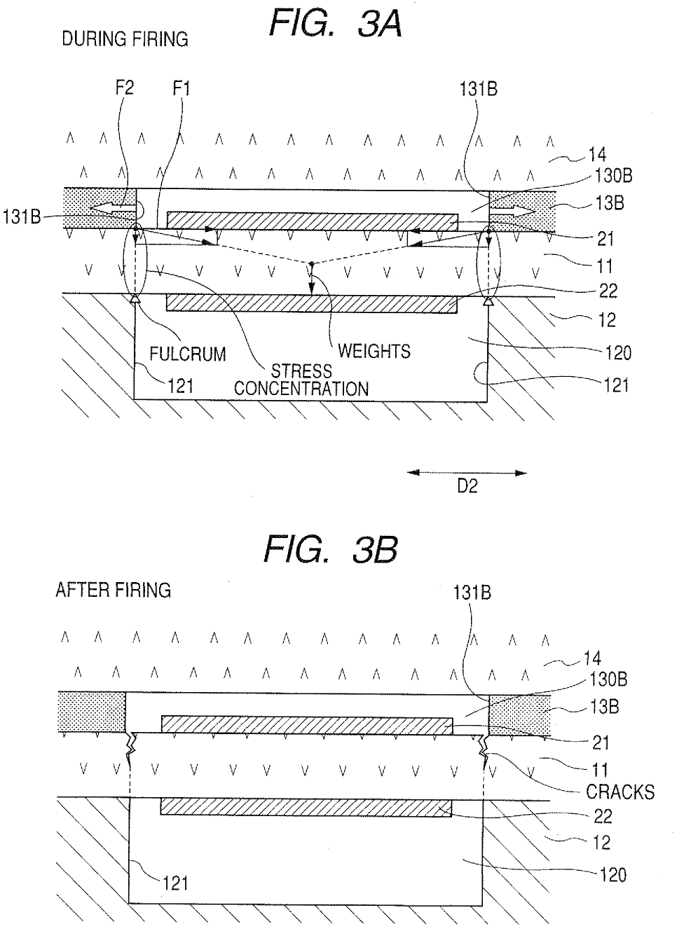

First, referring to FIG. 3A, in the conventional laminated gas sensor 1B, each of the inner side surfaces 131B of the measurement gas chamber formation layer 13B is located in the same position in the lateral direction D2 of the solid electrolyte layer 11 as the corresponding one of the inner side surfaces 121 of the reference gas chamber formation layer 12.

Due to the weight of that portion of the solid electrolyte layer 11 which is interposed between the gas chambers 130B and 120 and the weights of the measurement and reference electrodes 21 and 22, bending moments will act on the solid electrolyte layer 11 taking the intersections between the solid electrolyte layer 11 and the inner side surfaces 121 of the reference gas chamber formation layer 12 as fulcrums. The bending moments will induce inward tensions F1 that act on the solid electrolyte layer 11 at the intersections between the solid electrolyte layer 11 and the inner side surfaces 131B of the measurement gas chamber formation layer 13B.

Further, during the firing process in manufacturing the laminated gas sensor 1B, the measurement gas chamber formation layer 131B will shrink outward of the measure gas chamber 130B, inducing outward tensions F2 that also act on the solid electrolyte layer 11 at the intersections between the solid electrolyte layer 11 and the inner side surfaces 131B of the measurement gas chamber formation layer 13B.

Consequently, stress will be concentrated in portions of the solid electrolyte layer 11 around the intersections between the solid electrolyte layer 11 and the inner side surfaces 131B of the measurement gas chamber formation layer 131B, causing cracks to occur in those portions as shown FIG. 3B.

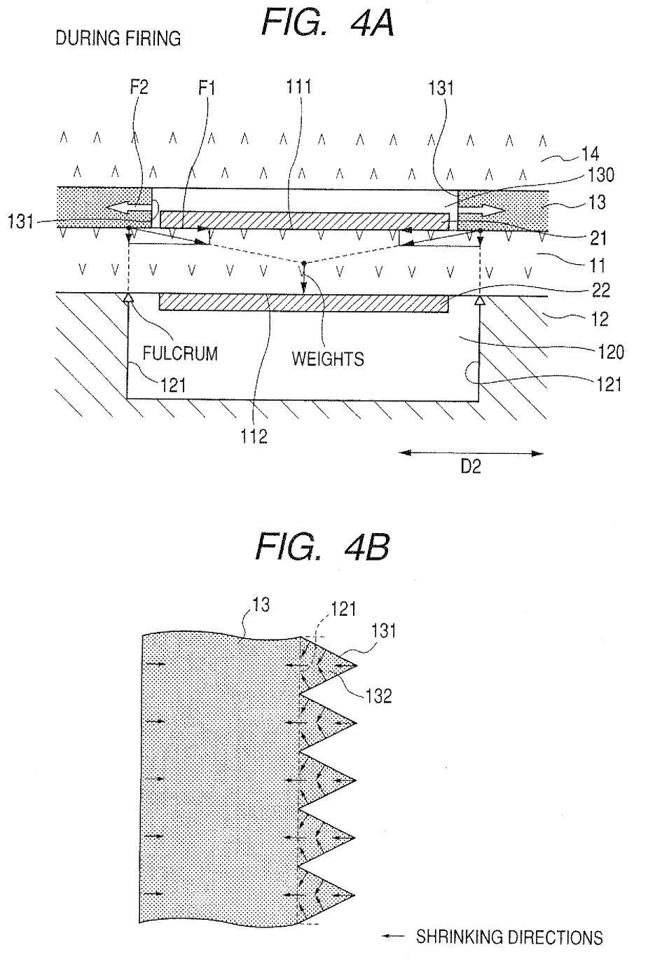

In comparison, referring to FIG. 4A, in the laminated gas sensor 1 of the present embodiment, the inner side surfaces 131 of the measurement gas chamber formation layer 13 are located inner than the inner side surfaces 121 of the reference gas chamber formation layer 12. That is, the intersections between the solid electrolyte layer 11 and the inner side surfaces 131 of the measurement gas chamber formation layer 13 are staggered from those between the solid electrolyte layer 11 and the inner side surfaces 121 of the reference gas chamber formation layer 12 in the lateral direction D2 of the solid electrolyte layer 11.

As in the conventional laminated gas sensor 1B, bending moments will act on the solid electrolyte layer 11 taking the intersections between the solid electrolyte layer 11 and the inner side surfaces 121 of the reference gas chamber formation layer 12 as fulcrums. The bending moments will induce inward tensions F1 that act on the upper surface 111 of the solid electrolyte layer 11 at lateral positions corresponding to the intersections between the solid electrolyte layer 11 and the inner side surfaces 121 of the reference gas chamber formation layer 12.

Further, during the firing process in manufacturing the laminated gas sensor 1, the measurement gas chamber formation layer 13 will shrink outward of the measure gas chamber 130, inducing outward tensions F2 that act on the solid electrolyte layer 11 at the intersections between the solid electrolyte layer 11 and the inner side surfaces 131 of the measurement gas chamber formation layer 13.

However, since the acting positions of the outward tensions F2 are staggered from those of the inward tensions F1, the outward tensions F2 will be canceled by the inward tensions F1.

Consequently, stress will be significantly alleviated in portions of the solid electrolyte layer 11 around the intersections between the solid electrolyte layer 11 and the inner side surfaces 131 of the measurement gas chamber formation layer 13, thereby reliably preventing cracks from occurring in the solid electrolyte layer 11.

Further, referring to FIG. 4B, there are provided the stress deconcentration portions 132 in the measurement gas chamber formation layer 13. With this stress deconcentration portions 132, stress will be further alleviated around the intersections between the solid electrolyte layer 11 and the inner side surfaces 131 of the measurement gas chamber formation layer 13, thereby further reliably preventing cracks from occurring in the solid electrolyte layer 11.

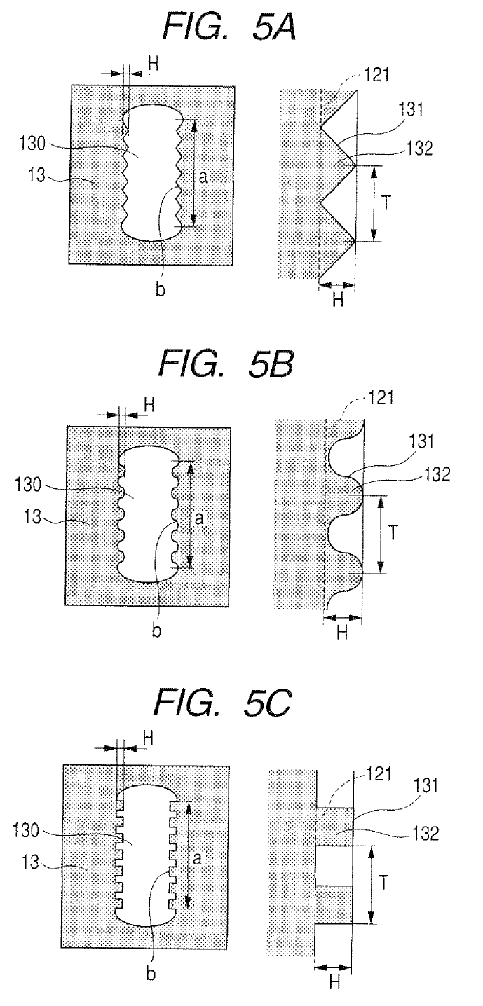

FIGS. 5A, 5B and 5C illustrate variations of the stress deconcentration portions 132 of the measurement gas formation chamber 13.

In the first variation shown in FIG. 5A, the cross section of each of the stress deconcentration portions 132 is shaped in a triangular wave.

In the second variation shown in FIG. 5B, the cross section of each of the stress deconcentration portions 132 is shaped in a sine wave.

In the third variation shown in FIG. 5C, the cross section of each of the stress deconcentration portions 132 is shaped in a rectangular wave.

In each of the three variations shown in FIGS. 5A-5C, a represents the straight length of each of the stress deconcentration portions 132, b represents the surface length of each of the stress deconcentration portions 132, H represents the height of the wave forming the cross-section of each of the deconcentration portions 132, and T represents the pitch of the wave. Additionally, let n represent the number of pairs of top and bottom in the wave, then T is equal to (a/n).

Further, in each of the three variations, there are defined the following relationships:

0.2 T<H<2.5 T;

1≦n≦50; and

1.1a≦b≦5a.

A large H is preferable in terms of decreasing the occurrence rate of cracks in the solid electrolyte layer 11. However, when H is made so large as to exceed the above upper limit, the volume of the measurement gas chamber 130 will be accordingly decreased, forcing the width of the measurement electrode 21 to be accordingly decreased. In this case, to keep the width of the measurement electrode 21 constant and thereby to secure the responsivity of the laminated gas sensor 1, it is necessary to increase the volume of the measurement gas chamber 130 by increasing the width of the solid electrolyte layer 11. However, as the width of the solid electrolyte layer 11 increases, the heat capacity of the same accordingly increases, thereby increasing the heating time required to activate the solid electrolyte layer 11.

On the contrary, when H is made smaller than the above lower limit, the inner side surfaces 131 of the measurement gas chamber formation layer 13 will be almost flat, making it difficult to secure the effect of the stress deconcentration portions 132.

The advantages of the laminated gas sensor 1 according to the present embodiment have been confirmed through an experimental investigation.

In the investigation, five different types A-E of sample laminated gas sensors were tested. Among them, the type A was identical to the conventional laminated gas sensor 1B described previously. The types B-E had the same structure as the laminated gas sensor 1 of the present embodiment, but various values of the above-defined parameters. More specifically, the type B had H of 0.32 mm, n of 10, and b of equal to 1.05 a; the type C had H of 0.46 mm, n of 10, and b of equal to 1.1 a; the type D had H of 0.56 mm, n of 20, and b of equal to 1.5 a; and the type E had H of 0.87 mm, n of 20, and b of equal to 2 a.

Further, for each of the types B-E, a was 8 mm, and the shape of cross sections of the stress deconcentration portions 132 of the solid electrolyte layer 11 was a sine wave as shown in FIG. 5B. All the types A-E were evaluated in terms of occurrence rate of cracks.

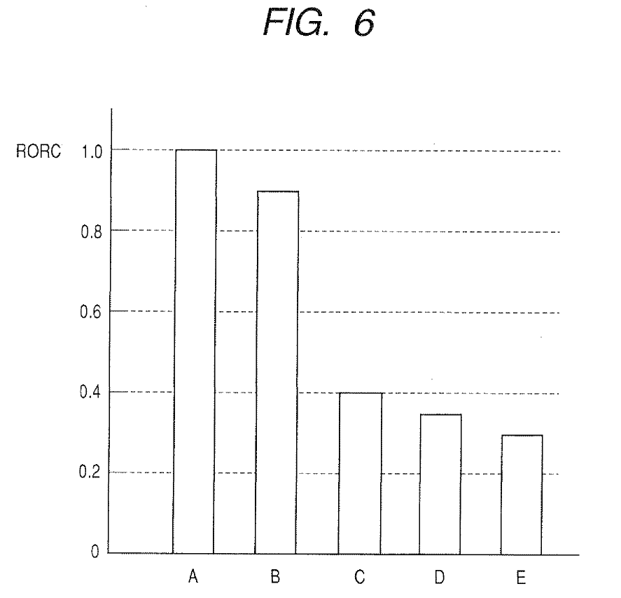

The evaluation results are shown in Table 1 and FIG. 6, where the occurrence rate of cracks for each of the types A-E is reduced to a Relative Occurrence Rate of Cracks (RORC) which takes the occurrence rate of cracks for the type A as a reference value of 1.

TABLE 1

| | TYPE A | TYPE B | TYPE C | TYPE D | TYPE E |
|---|---|---|---|---|---|
| H (mm) | — | 0.32 | 0.46 | 0.56 | 0.87 |
| T (mm) | — | 0.8 | 0.8 | 0.4 | 0.4 |
| n | — | 10 | 10 | 20 | 20 |
| RORC | 1 | 0.9 | 0.4 | 0.35 | 0.3 |

As can be seen from FIG. 6, all the types B-E had a lower occurrence rate of cracks than the type A, and the occurrence rate of cracks decreased with increase in H.

In other words, the laminated gas sensor 1 according to the present embodiment is superior to the conventional laminated gas sensor 1B in terms of preventing occurrence of cracks in the solid electrolyte layer 11 during manufacturing. Moreover, a larger H is more preferable as long as it remains within the range specified above.

While the above particular embodiment of the invention has been shown and described, it will be understood by those skilled in the art that various modifications, changes, and improvements may be made without departing from the spirit of the invention.

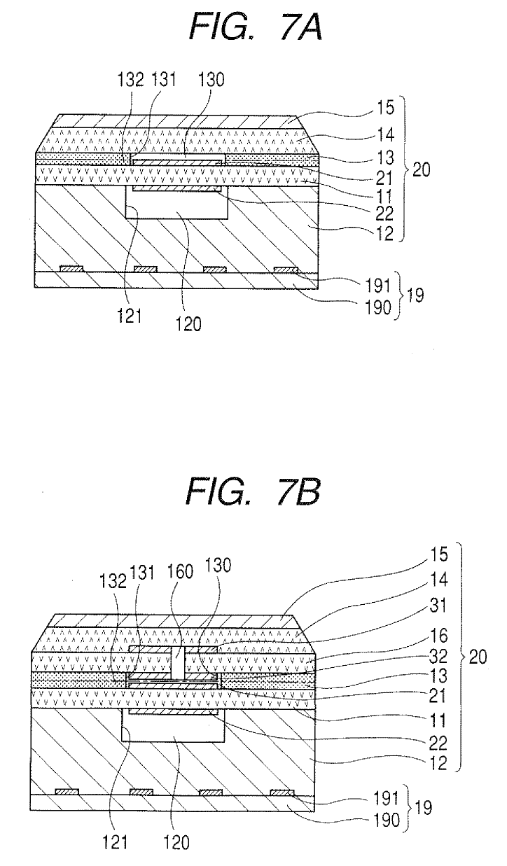

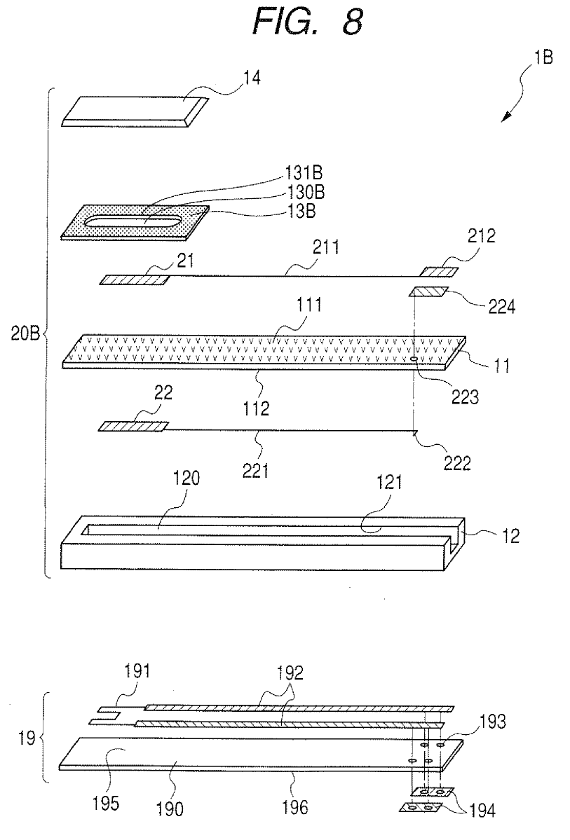

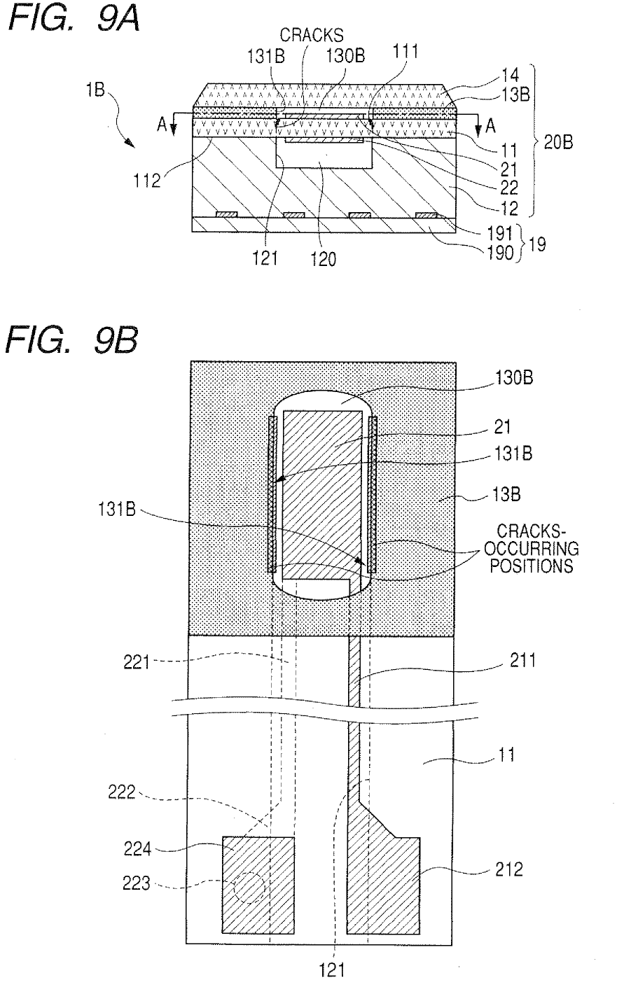

For example, as shown in FIG. 7A, it is possible for the laminated gas sensor 1 to further include a gas-shielding layer 15 to cover the gas diffusion layer 14, thereby increasing the diffusion resistance. In other words, the laminated gas sensor 1 may be of a limited current type.

Moreover, the previous embodiment is directed to the laminated gas sensor 1 which is of a one cell type. However, the present invention also can be applied to a laminated gas sensor of a two-cell type as shown in FIG. 7B, where additional components, including a second solid electrolyte layer 16, electrodes 31 and 32, and a pin hole 160, are further added to the configuration of the laminated gas sensor 1. The additional components make up a pump cell, thereby improving the accuracy of the laminated gas sensor.

Furthermore, the present invention also can be applied to any ceramic laminate which has a similar structure to the laminated gas sensor 1.

What is claimed is:

1. A laminated gas sensor comprising:
a solid electrolyte layer having an opposite pair of first and second major surfaces, the first and second major surfaces having a length and a width, thereby defining longitudinal and lateral directions of the solid electrolyte layer;
a measurement gas chamber and a reference gas chamber which are respectively formed on the first and second major surfaces of the solid electrolyte layer and into which a gas to be measured and a reference gas are to be respectively introduced;
a measurement electrode that is provided on the first major surface of the solid electrolyte layer and within the measurement gas chamber, so as to be exposed to the gas;
a reference electrode that is provided on the second major surface of the solid electrolyte layer and within the reference gas chamber, so as to be exposed to the reference gas;
a measurement gas chamber formation layer having a first hollow space formed therein and being laminated on the first major surface of the solid electrolyte layer so that the first hollow space makes up the measurement gas chamber, the measurement gas chamber formation layer having an opposite pair of inner side surfaces that extend in the longitudinal direction of the solid electrolyte layer and face each other in the lateral direction of the solid electrolyte layer through the measurement gas chamber formed therebetween; and
a reference gas chamber formation layer having a second hollow space formed therein and being laminated on the second major surface of the solid electrolyte layer so that the second hollow space makes up the reference gas chamber, the reference gas chamber formation layer having an opposite pair of inner side surfaces that extend in the longitudinal direction of the solid electrolyte layer and face each other in the lateral direction of the solid electrolyte layer through the reference gas chamber formed therebetween;
wherein at least one of the inner side surfaces of the measurement gas chamber formation layer is located more inside the laminated gas sensor than a corresponding one of the inner side surfaces of the reference gas chamber formation layer in the lateral direction of the solid electrolyte layer.

2. The laminated gas sensor as set forth in claim 1, wherein the at least one of the inner side surfaces of the measurement gas chamber formation layer extends in zigzags in the longitudinal direction of the solid electrolyte layer, forming a stress deconcentration portion of the measurement gas chamber formation layer which protrudes inward from the corresponding one of the inner side surfaces of the reference gas chamber formation layer in the lateral direction of the solid electrolyte layer.

3. The laminated gas sensor as set forth in claim 2, wherein the stress deconcentration portion of the measurement gas chamber formation layer has a cross section which is parallel to the first major surface of the solid electrolyte layer and shaped in a wave that includes a plurality of tops and bottoms alternately arranged in the longitudinal direction of the solid electrolyte layer.

4. The laminated gas sensor as set forth in claim 3, wherein the wave is a triangular wave.

5. The laminated gas sensor as set forth in claim 3, wherein the wave is a sine wave.

6. The laminated gas sensor as set forth in claim 3, wherein the wave is a rectangular wave.

7. The laminated gas sensor as set forth in claim 3, wherein 0.2 T<H<2.5 T, where T is a pitch of the wave, and H is a height of the wave.

8. The laminated gas sensor as set forth in claim 7, wherein the wave includes less than or equal to 50 pairs of tops and bottoms.
